(19) United States
(12) Patent Application Publication
(10) Pub. No.: US 2025/0236209 A1
(43) Pub. Date: Jul. 24, 2025

(54) APPARATUS AND METHOD CAPABLE OF PERFORMING VEHICLE-TO-VEHICLE HEAT MANAGEMENT

(71) Applicants: HYUNDAI MOTOR COMPANY, Seoul (KR); KIA CORPORATION, Seoul (KR)

(72) Inventors: Yeon Ho Kim, Seoul (KR); Wook Hyun Han, Seoul (KR); Jae Hyuk Choi, Seoul (KR); Seung Yong Kwak, Anyang-si (KR); Dong Gil Ha, Yongin-si (KR)

(73) Assignees: HYUNDAI MOTOR COMPANY, Seoul (KR); KIA CORPORATION, Seoul (KR)

(21) Appl. No.: 18/659,603

(22) Filed: May 9, 2024

(30) Foreign Application Priority Data
Jan. 18, 2024 (KR) 10-2024-0007746

(51) Int. Cl. B60L 58/24; B60H 1/00; B60L 50/60; B60L 50/70; B60L 53/18; B60L 53/53; B60L 58/33; H01M 8/04029; H01M 10/613; H01M 10/615; H01M 10/625; H01M 10/63; H01M 10/6568

(52) U.S. Cl. CPC B60L 58/24; B60H 1/00278; B60H 1/00885; B60L 50/60; B60L 50/70; B60L 53/18; B60L 53/53; B60L 58/33; H01M 8/04029; H01M 10/613; H01M 10/615; H01M 10/625; H01M 10/63; H01M 10/6568; H01M 2220/20; H01M 2250/20

(57) ABSTRACT

An apparatus for performing vehicle-to-vehicle charging includes a charging cable having a fluid tube along which a cooling fluid flows configured to connect a vehicle equipped with a battery and a charging vehicle supplying electric power for charging the battery of the vehicle requiring a charge, a cooling device provided in the charging vehicle and configured to cool the cooling fluid, a heat supply device provided in the charging vehicle configured to supply heat to the cooling fluid, and a fluid regulation device configured to regulate the flow of the cooling fluid in such that the cooling fluid having been cooled by the cooling device or heated by the heat supply device in the charging vehicle is supplied to the vehicle requiring a charge along the fluid tube, in order to cool or increase the temperature of the battery of the vehicle requiring a charge using the cooling fluid.

### CROSS-REFERENCE TO RELATED APPLICATION

This application claims, under 35 U.S.C. § 119(a), the benefit of and priority to Korean Patent Application No. 10-2024-0007746 filed on Jan. 18, 2024, the entire contents of which are incorporated herein by reference.

### BACKGROUND

### (a) Technical Field

The present disclosure relates to an apparatus and a method for performing vehicle-to-vehicle (V2V) heat management for adjusting and maintaining a temperature of a battery.

### (b) Background Art

As known, electric vehicles are equipped with a battery and a motor and travel by driving the motor using electric power stored in the battery. The electric vehicle is connected to a charger installed at a charging station or other charging place, or to an external electric power source capable of supplying electric power for charging the battery of the electric vehicle.

In addition, the electric vehicle is equipped not only with a battery capable of supplying electric power for operating the motor driving the electric vehicle, but also with an on-board charger (OBC) for charging the battery of the electric vehicle. The on-board charger includes an electric power conversion device, such as a converter or an inverter, that converts electric power (e.g., between alternating and direct current) and outputs the resulting converted power.

In recent years, with a significant increase in electric vehicle usage, V2X technologies that use the electric power of the vehicle have been commercialized or are being developed. For example, there are known vehicle-to-load (V2L) technologies, which can supply electric power from a vehicle to an electric load that is connected to a vehicle, and vehicle-to-grid (V2G) technologies, which can not only supply electric power in a smart grid to a vehicle, but can also supply electric power from a vehicle to the smart grid.

In addition, there are known vehicle-to-vehicle (V2V) technologies, which can quickly or slowly charge a battery of a vehicle by supplying electric power from one vehicle to another different vehicle. Additionally, there are known vehicle-to-home (V2H) technologies, which can supply electric power from a vehicle to a home for home use. These V2L, V2G, V2V, and V2H technologies, which enable electric power in a vehicle to be used outside of the vehicle, are collectively referred to as V2X technologies.

The V2V technologies, which are technologies for vehicle-to-vehicle electric power transmission, are primarily related to charging an electric vehicle using a different electric vehicle, that is, performing vehicle-to-vehicle charging after an electric vehicle (charging vehicle) capable of supplying electric power for charging a battery is connected to a different electric vehicle in need of charging (vehicle requiring a charge). Through these V2V technologies, a mobile charging service can be realized where battery charging is performed by connecting an electric power supply vehicle to a vehicle in urgent need of charging.

The mobile charging service can save time and money by reducing the time and a traveling distance (e.g., of the vehicle requiring a charge) required to charge an electric vehicle. Furthermore, an owner of an electric vehicle capable of performing the mobile charging service can earn money by providing the mobile charging service.

In addition, charging stations for typical electric vehicles have the disadvantages of high costs associated with the following: securing a predetermined sized area; purchasing the area; purchasing and installing chargers; maintaining the charging station and chargers; and consuming electric power in the charging station.

In contrast, in the case of the mobile charging service that uses the V2V technology, it only an initial investment to manufacture an electric vehicle capable of charging batteries of other vehicles is required. Therefore, the initial investment is not high. Operational costs such as electricity, vehicle maintenance, and driver salaries are necessary. Due to these factors, the mobile charging service is cost-effective and can be provided on a relatively small scale, compared to existing charging stations.

When charging the battery of a vehicle, the state (e.g., temperature) of the vehicle battery has a significant influence on charging efficiency. Accordingly, when performing vehicle-to-vehicle charging that uses the V2V technology, it is also necessary to maintain the state of a battery being charged. However, up to now, there has been no technology that is capable of optimally controlling the state of a battery being charged in a vehicle on which V2V charging can be performed.

### SUMMARY OF THE DISCLOSURE

An object of the present disclosure, which is provided to address the above-mentioned problem, is to provide a vehicle-to-vehicle heat management apparatus and method that are capable of adjusting and maintaining an optimal state of battery that is charged while battery charging is performed using a vehicle-to-vehicle (V2V) technology.

In order to accomplish the above-mentioned object, according to one aspect of the present disclosure, there is provided an apparatus for performing vehicle-to-vehicle heat management. The apparatus for performing vehicle-to-vehicle heat management includes: a charging cable having a fluid tube along which a cooling fluid flows. The charging cable is configured to connect a vehicle requiring a charge equipped with a battery and a charging vehicle supplying electric power for charging the battery of the vehicle requiring a charge (namely, a charging-required vehicle). The apparatus further includes: a cooling device provided in the charging vehicle and configured to cool the cooling fluid; a heat supply device provided in the charging vehicle and configured to supply heat to the cooling fluid; and a fluid regulation device configured to regulate the flow of the cooling fluid such that the cooling fluid cooled or heated by the cooling device or the heat supply device, respectively, of the charging vehicle is selectively supplied to the vehicle requiring a charge along the fluid tube of the charging cable, in order to increase the temperature of or cool the battery of the vehicle requiring a charge using the cooling fluid.

The apparatus may further include a heat exchange passage provided in the battery of the vehicle requiring a charge such that the cooling fluid supplied along the fluid tube of the charging cable flows through the heat exchange passage and that the battery is cooled or a temperature of the battery is increased while the cooling fluid flows through the heat exchange passage.

In the apparatus, the fluid tube may include: a supply tube along which the cooling fluid is supplied from the charging vehicle to the charging-required vehicle; and a recovery tube along which the cooling fluid that cools or increases the temperature of the battery is returned from the charging-required vehicle to the charging vehicle.

In the apparatus, the cooling device may include: a radiator, wherein heat carried by the cooling fluid is dissipated in the radiator; and a cooling fan configured to blow air into the radiator.

In the apparatus, the cooling device may include: a chiller configured to cool the cooling fluid by heat exchange with a refrigerant.

In the apparatus, the heat supply device may include: a power electronics component generating heat when charged using a battery of the charging vehicle that supplies electric power for charging the battery of the vehicle requiring a charge, and wherein the cooling fluid may be a coolant that cools the battery of the charging vehicle and the power electronics component.

In the apparatus, the charging vehicle may supply electric power generated in a fuel cell stack, which is a primary electric power source, or electric power stored in a battery of the charging vehicle, which is an auxiliary electric power source, to the battery of the vehicle requiring a charge.

In the apparatus, the cooling fluid may be a coolant configured to cool the fuel cell stack, and the cooling device may include: a radiator, wherein heat carried by the cooling fluid is dissipated in the radiator; and a cooling fan configured to blow air into the radiator.

In the apparatus, the heat supply device may be a fuel cell stack that generates electric power while the battery of the vehicle requiring a charge is charged, and the cooling fluid may be a coolant that cools the fuel cell stack.

In the apparatus, the fluid regulation device may include: a controller configured to determine a heat management mode based on battery state information of the vehicle requiring a charge received from the vehicle requiring a charge via the charging cable, and output a control signal according to the determined heat management mode. The fluid regulation device further includes a pump and a fluid regulation valve. In particular, operation of the pump and the fluid regulation device is controlled by the control signal output by the controller, such that one of the cooling fluids, cooled by the cooling device or heated by the heat supply device, respectively, is supplied to a charging port of the charging vehicle, the fluid tube of the charging cable being connected to the charging port.

According to another aspect of the present disclosure, there is provided an apparatus for performing vehicle-to-vehicle heat management. The apparatus includes: a charging cable having a fluid tube along which a cooling fluid for cooling or increasing the temperature a battery of a vehicle requiring a charge flows. The charging cable is configured to connect the vehicle requiring a charge equipped with the battery and a charging vehicle supplying electric power for charging the battery of the vehicle requiring a charge. The apparatus includes: a heat exchange passage provided in the battery of the vehicle requiring a charge, such that, the cooling fluid supplied along the fluid tube of the charging cable flows through the heat exchange passage and the battery is cooled or a temperature of the battery is increased while the cooling fluid flows through the heat exchange passage.

According to still another aspect of the present disclosure, a vehicle-to-vehicle heat management method includes: determining, by a controller, whether or not a charging-ON signal is input when a vehicle requiring a charge equipped with a battery and a charging vehicle supplying electric power for charging the battery of the vehicle requiring a charge are connected to each other by a cable having a fluid tube along which a cooling fluid flows; and receiving, by the controller, battery state information of the vehicle requiring a charge via the charging cable when it is determined that the charging-ON signal is input. The V2V heat management method further includes: determining, by the controller, a heat management mode based on the battery state information; and controlling, by the controller, an operation of a fluid regulation device such that the cooling fluid cooled by a cooling device or heated by a heat supply device in the charging vehicle is supplied to the vehicle requiring a charge along the fluid tube of the charging cable according to the determined heat management mode in order to cool or increase the temperature of the battery of the vehicle requiring a charge using the cooling fluid.

In the vehicle-to-vehicle heat management method, a heat exchange passage, through which the cooling fluid supplied from the charging vehicle along the fluid tube of the charging cable flows, may be provided in the battery of the vehicle requiring a charge.

In the vehicle-to-vehicle heat management method, the fluid tube may include: a supply tube along which the cooling fluid is supplied from the charging vehicle to the vehicle requiring a charge; and a recovery tube along which the cooling fluid that cools or increases the temperature of the battery is returned from the vehicle requiring a charge to the charging vehicle.

In the vehicle-to-vehicle heat management method, the cooling device may include: a radiator, wherein heat carried by the cooling fluid is dissipated in the radiator; and a cooling fan blowing air into the radiator.

In the vehicle-to-vehicle heat management method, the cooling device may include a chiller configured to cool the cooling fluid by heat exchange with a refrigerant.

In the vehicle-to-vehicle heat management method, the heat supply device may include: a power electronics component generating heat when charged using a battery of the charging vehicle that supplies electric power for charging the battery of the vehicle requiring a charge, and the cooling fluid may be a coolant that cools the battery of the charging vehicle and the power electronics component.

In the vehicle-to-vehicle heat management method, the charging vehicle may supply electric power generated in a fuel cell stack, which is a primary electric power source, or electric power stored in a battery of the charging vehicle, which is an auxiliary electric power source, to the battery of the vehicle requiring a charge.

In the vehicle-to-vehicle heat management method, the cooling fluid may be a coolant that cools the fuel cell stack, and the cooling device may include: a radiator, wherein heat carried by the cooling fluid is dissipated in the radiator; and a cooling fan configured to blow air into the radiator.

In the vehicle-to-vehicle heat management method, the heat supply device may be a fuel cell stack that generates electric power while the battery of the vehicle requiring a charge is charged, and the cooling fluid may be a coolant that cools the fuel cell stack.

Accordingly, with the vehicle-to-vehicle heat management apparatus and method according to the present disclosure, the state of a battery can be adjusted and maintained to an optimal state when battery charging is performed using vehicle-to-vehicle (V2V). In addition, efficiency in battery charging can be performed by performing vehicle-to-vehicle heat management. Electric energy necessary to temperature-increase and cool a battery in the charging-required vehicle can be saved, thereby reducing battery charging time.

### BRIEF DESCRIPTION OF THE DRAWINGS

The above and other features of the present disclosure are described in detail below with reference to several embodiments thereof illustrated in the accompanying drawings which are given herein below by way of illustration only, and thus do not limit the present disclosure, and wherein:

FIG. 1 is a cross-sectional view illustrating a charging cable of an apparatus for performing V2V heat management according to the present disclosure, the charging cable serving to connect vehicles to each other;

FIG. 2 and FIG. 3 each schematically illustrate a charging vehicle with which an apparatus or method of the present disclosure may be used;

FIG. 4 is a view illustrating a configuration of an apparatus for performing V2V heat management according to a first embodiment of the present disclosure;

FIG. 5 and FIG. 6 are views, each illustrating a state where the apparatus for performing V2V heat management according to the first embodiment of the present disclosure operate according to a heat management mode;

FIG. 7 is a view illustrating a configuration of an apparatus for performing V2V heat management according to a second embodiment of the present disclosure;

FIG. 8 and FIG. 9 are views, each illustrating a state where the apparatus for performing V2V heat management according to the second embodiment of the present disclosure operates according to the heat management mode;

FIG. 10 is a block diagram illustrating control constituent elements and operational constituent elements of the apparatus for performing heat management according to the present disclosure; and

FIG. 11 is a flowchart illustrating a V2V heat management method according to a third embodiment of the present disclosure.

### DETAILED DESCRIPTION

Embodiments of the present disclosure are described in detail below with reference to the accompanying drawings. The embodiments of the present disclosure are described below only in an illustrative manner in terms of specific structures and functions and, therefore, may be practiced in various forms without departing from the spirit and scope of the present disclosure. In addition, the present disclosure should not be construed as being limited to the embodiments described in the specification. All alterations, equivalents, and substitutes that are included within the spirit and scope of the technical idea or inventive concept of the present disclosure should be understood as falling within the scope of the present disclosure.

The ordinal numbers first, second, and/or so forth are used to describe various constituent elements in the specification, but without imposing any limitation thereon. Those ordinal numbers are used only to distinguish one constituent element from another. For example, a first constituent element may be named a second constituent element without departing from the scope of the claims that define the present disclosure. Likewise, the second constituent element may also be named the first constituent element.

It should be understood that a constituent element, when referred to as “is connected to” or “establishes a connection to” a different constituent element, may be directly connected to or establish a direct connection to the different constituent element or may be connected to or establish a direct connection to the different constituent element, with an intervening constituent element in between. In contrast, it should be understood that a constituent element, when referred to as “is directly connected to” or “establishes a direct connection to” a different constituent element, is connected to or establishes a connection to the different constituent, without any intervening constituent element in between. Likewise, this interpretation should apply to expressions such as “between” and “directly between” and expressions such as “adjacent to” and “directly adjacent to” that are used for describing a relationship between constituent elements.

Like reference numerals depict like constituent elements throughout the present specification. The terms used throughout the present specification serve the purpose of describing the embodiments, but do not impose any limitation on the present disclosure. Unless specially stated otherwise throughout the present specification, a singular noun or a singular noun phrase may have a plural meaning. The verbs “comprise” and/or “comprising” used in the specification should be construed to mean “including the following constituent element, step, operation, or element, but not excluding one or more other constituent elements, steps, operations, or elements.” When a component, device, element, or the like of the present disclosure is described as having a purpose of performing an operation, function, or the like, the component, device, or element should be considered herein as being “configured to” meet that purpose or perform that operation or function.

The present disclosure relates to an apparatus and a method for performing vehicle-to-vehicle (V2V) heat management. According to the present disclosure, V2V heat management is performed by supplying and circulating a cooling fluid (heat medium, heat carrying medium) between an electric power supply (a charging vehicle) and a vehicle requiring a charge (namely, a charging-required vehicle) or in need of a battery charge in order to adjust and maintain the temperature of a battery being charged at an optimal state when performing V2V battery charging between electric vehicles.

The electric power supply vehicle and the vehicle requiring a charge may both be electric vehicles. In addition, the electric power supply vehicle and the vehicle requiring a charge are vehicles capable of performing the V2V battery charging. The electric power supply vehicle here is a vehicle having a purpose of supplying electric power in order to perform battery charging on a different vehicle after being connected to the different vehicle through a charging cable.

The term “charging vehicle,” used hereinafter, refers to both the electric power supply vehicle and the charging-purposed vehicle. These vehicles each include some constituent elements of the apparatus capable of performing heat management according to the present disclosure and are capable of supplying electric power for battery charging to a different vehicle after being connected to the different vehicle. In addition, a vehicle which is connected to the charging vehicle and of which a battery is charged with electric power supplied from the charging vehicle is hereinafter referred to as a “vehicle requiring a charge.” or “a charging-required vehicle”.

The charging vehicle may be a vehicle that provides a charging service and receives payment for providing the charging service, that is, may be a vehicle that provides a V2V mobile charging service. In addition, the charging vehicle, like the vehicle requiring a charge, may be a battery electric vehicle (BEV) equipped with a high-voltage battery and may be a fuel cell electric vehicle (FCEV) equipped with a fuel cell that is a high-voltage electric power supply device capable of supplying battery charging electric power.

The fuel cell here may be a polymer electrolyte membrane fuel cell (PEMFC) that uses hydrogen as fuel gas and uses oxygen or air containing oxygen as oxidizing gas. In typical fuel cell vehicles, the fuel cell refers to a fuel cell stack that is configured by stacking a plurality of unit cells on top of each other to satisfy a required output.

In addition, the vehicle requiring a charge is a vehicle which is in need of battery charging and of which a battery is charged with electric power supplied from the charging vehicle through a charging cable after being connected to the charging vehicle through the charging cable.

According to the present disclosure, the apparatus for performing V2V heat management (hereinafter referred to as a “heat management performing vehicle” for short) performs heat management for optimal charging of a battery to be charged. This heat management is performed by circulating a cooling fluid (heat medium) between the charging vehicle and the vehicle requiring a charge that are connected to each other through a charging cable during battery charging. The cooling fluid here may be a coolant.

According to the present disclosure, the heat management may include battery temperature control (increasing the temperature of the battery or battery cooling) that controls or maintains a battery of the vehicle requiring a charge at an optimal charging temperature by supplying or circulating the cooling fluid (heat medium) between the charging vehicle and the vehicle requiring a charge through a charging cable.

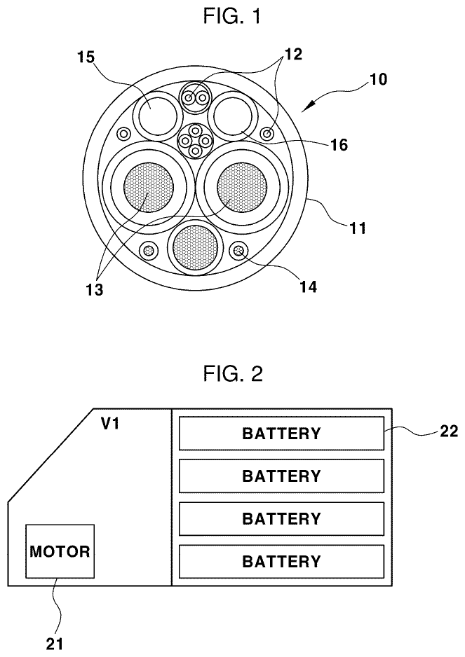

FIG. 1 is a cross-sectional view illustrating a charging cable 10 of the apparatus for performing V2V heat management according to the present disclosure, the charging cable 10 serving to connect vehicles to each other. The charging cable 10 here is connected to respective charging ports in the charging vehicle and the vehicle requiring a charge through respective charging connectors on both end portions of the charging cable 10.

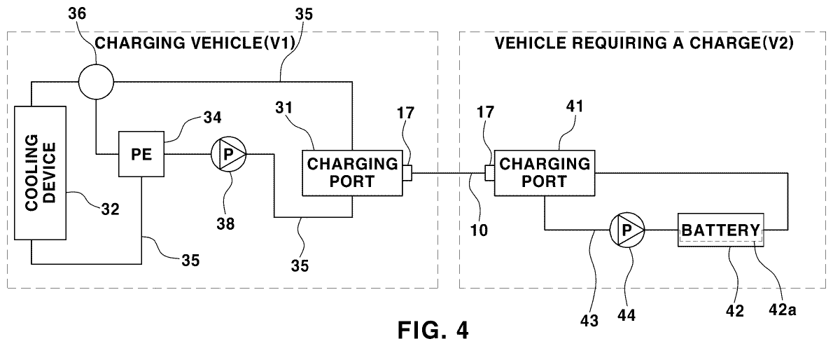

In addition, the charging cable 10 may be one that is connected in a fixed state to the vehicle in such a manner as not to be separated therefrom. In this case, a fluid tube (indicated by both reference numerals 15 and 16) of the charging cable 10 may be directly connected to fluid circulation lines, respectively, (which are indicated by reference numerals 35 and 43, respectively, in FIG. 4) of the charging vehicle and the vehicle requiring a charge. The fluid circulation lines are described below.

According to the present disclosure, the charging vehicle, which supplies electric power for charging a battery, and the vehicle requiring a charge, which is supplied with electric power for charging the battery, include charging ports (indicated by reference numerals 31 and 41 in FIG. 4), respectively, to which the charging cable 10 can be connected.

The charging cable 10 is a cable that connects the charging vehicle and the vehicle requiring a charge for the V2V battery charging and has an electric power line over which electric power can be supplied from the charging vehicle to the vehicle requiring a charge.

The charging connectors (indicated by reference numerals 17 in FIG. 4) are connected on both end portions, respectively, of the charging cable 10. During battery charging, one of two connectors installed on both end portions, respectively, of the charging cable 10 is connected to the charging port in the charging vehicle, and the other to the charging port in the vehicle requiring a charge.

According to the present disclosure, the charging cable 10, as illustrated in FIG. 1, may include constituent elements of a typical charging cable for charging an electric vehicle, for example, conductive lines, such as a plurality of signal lines 12, an electric power line 13, and a grounding line 14. Furthermore, the charging cable 10 may be configured to include a cable sheath 11 within which the conductive lines, such as the plurality of signal lines 12, the electric power line 13, and the grounding line 14 are disposed.

Moreover, in addition to typical constituent elements for charging the battery of the electric vehicle, the charging cable 10 may further include the fluid tube (indicated by both reference numerals 15 and 16) along which the cooling fluid (e.g., heat carrying medium) flows. The fluid tube is provided for the flow and circulation of the cooling fluid between the charging vehicle and the vehicle requiring a charge. The fluid tube may also be provided in a state of being accommodated within the cable sheath 11.

The fluid tube of the charging cable 10 includes the supply tube 15 and a recovery tube 16. In a state where both end portions of the charging cable 10 are connected to the charging ports, respectively, in the charging vehicle and the vehicle requiring a charge, the cooling fluid flows from the charging vehicle to the vehicle requiring a charge along the supply tube 15, and the cooling fluid flows from the vehicle requiring a charge to the charging vehicle along the recovery tube 16.

In a state where the charging cable 10 connects the charging vehicle and the vehicle requiring a charge, the cooling fluid circulates between the charging vehicle and the vehicle requiring a charge while the battery of the vehicle requiring a charge is charged. In addition, the battery of the vehicle requiring a charge can be cooled and a temperature of the battery of the vehicle requiring a charge may be—increased by the cooling fluid that circulates between the charging vehicle and the vehicle requiring a charge. Accordingly, the temperature of the battery being charged can be controlled or maintained in an optimal state.

While the cooling fluid circulates in this manner, the charging vehicle supplies the cooling fluid to the vehicle requiring a charge through the supply tube 15 of the charging cable 10. The coolant that cools or increases the temperature of the battery of the vehicle requiring a charge returns, for recovery, to the charging vehicle along the recovery tube 16 of the charging cable 10.

FIG. 1 illustrates a cross section of the charging cable 10, depicting a configuration thereof. However, tube connection components for connecting the fluid tube (indicated by both reference numerals 15 and 16) of the charging cable 10 are provided at the charging connectors installed on both ends of the charging cable 10 and the charging ports in the charging vehicle and the vehicle requiring a charge, the charging connectors being coupled to the charging ports, respectively, for fastening.

Accordingly, when the charging connector is connected to the charging port, the cooling fluid that flows through the fluid tube (indicated by both reference numbers 15 and 16) of the charging cable 10 is enabled to flow along the fluid circulation line of each of the charging vehicle and the vehicle requiring a charge through the charging connector and the charging port, In addition, the cooling fluid that circulates along the fluid circulation line of each of the charging vehicle and the vehicle requiring a charge is enabled to flow along the fluid tube (indicated by both reference numbers 15 and 16) of the charging cable 10 through the charging connector and the charging port.

Accordingly, the fluid tube (indicated by both reference numbers 15 and 16) of the charging cable 10 may be connected to the charging vehicle and the vehicle requiring a charge in such a manner that the cooling fluid (e.g., heat carrying medium) can be supplied and recovered. Furthermore, through the charging cable 10, the fluid circulation line in the charging vehicle and the fluid circulation line in the vehicle requiring a charge can be connected to each other in such a manner that a fluid flows and circulates between both sides.

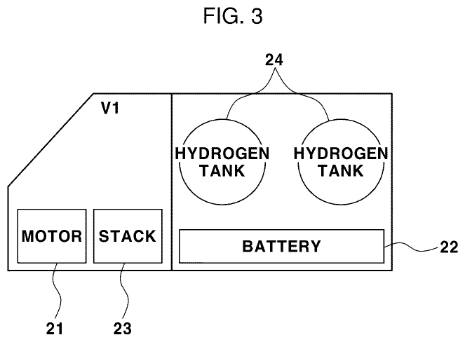

FIGS. 2 and 3 are views schematically illustrating charging vehicles with which the apparatuses and methods of the present disclosure may be used. FIG. 2 illustrates an example where a charging vehicle V1 is a battery electric vehicle. FIG. 3 illustrates an example where the charging vehicle V1 is a fuel cell vehicle.

As described above, according to the present disclosure, the charging vehicle may be a battery electric vehicle equipped with a motor 21 and a battery 22, or may be a fuel cell vehicle equipped with the motor 21 and a fuel cell stack 23 that is a high-voltage electric power device. The battery electric vehicle and the fuel cell are considered to be electric vehicles in a broad sense because they are driven by the motor 21.

According to the present disclosure, in a case where the charging vehicle V1 is a battery electric vehicle, the charging vehicle V1 includes a charging interface for connection to an external power source in such a manner as to be supplied from the outside with electric power for battery charging. The charging interface may be a charging port to which the above-described charging cable 10 is connected, and this charging port may also be used as a charging interface for charging a battery of the charging vehicle V1.

According to present disclosure, the charging vehicle V1 may be a charging service-dedicated vehicle, as a purpose-built vehicle (PBV), that is configured to provide a mobile charging service.

FIG. 2 illustrates a battery electric vehicle, as the charging vehicle V1, that is equipped with a high-capacity battery or a plurality of batteries 22, as well as with the motor 21 for driving the vehicle. FIG. 3 illustrates a fuel cell vehicle, as the charging vehicle V1, that is equipped with the fuel cell stack 23, as well as with the motor 21.

The charging vehicle V1, a fuel cell electric vehicle, may be equipped with a single hydrogen tank 24 or a plurality of hydrogen tanks 24 in which hydrogen, a fuel gas, is stored. Furthermore, in addition to the fuel cell stack 23, which is a primary electric source, the charging vehicle V1 may be equipped with the battery 22, which is an auxiliary electric power source.

Although not illustrated in FIG. 3, the charging vehicle V1, a fuel cell electric vehicle, may be equipped with well-known devices and components, such as a fuel cell operating device and a hydrogen charging inlet, that are necessary in typical fuel cell electric vehicles.

Accordingly, in a case where the charging vehicle V1 is a battery electric vehicle (BEV), electric power stored in the battery 22 may be supplied through the charging cable 10 as electric power for charging the battery of the vehicle requiring a charge.

In contrast, in a case where the charging vehicle V1 is a fuel cell electric vehicle (FCEV), electric power generated in the fuel cell stack 23 or electric power in the battery 22 may be supplied through the charging cable 10 as electric power for charging the battery of the vehicle requiring a charge.

In a case where the battery electric vehicle is used as the charging vehicle, the battery electric vehicle has the advantage of being readily manufactured. In a case where the fuel cell electric vehicle is used as the charging vehicle, the fuel cell electric vehicle has a large amount of stored energy, compared or relative to weight of the fuel cell electric vehicle, and thus is useful as an electric power supply vehicle for the V2V battery charging.

In the case of the battery electric vehicle, during the V2V battery charge, a component thereof that generates heat is the battery 22. In the case of the fuel cell electric vehicle, during the V2V battery charge, a component thereof that generates heat is the fuel cell stack 23. In the fuel cell electric vehicle, the fuel cell stack 23, which is a primary electric power source, and the battery 22, which is an auxiliary electric power source, may be used as components that generate heat.

FIG. 4 is a view illustrating a configuration of an apparatus capable of performing V2V heat management according to a first embodiment of the present disclosure. FIG. 4 assumes that the charging vehicle V1 is a battery electric vehicle.

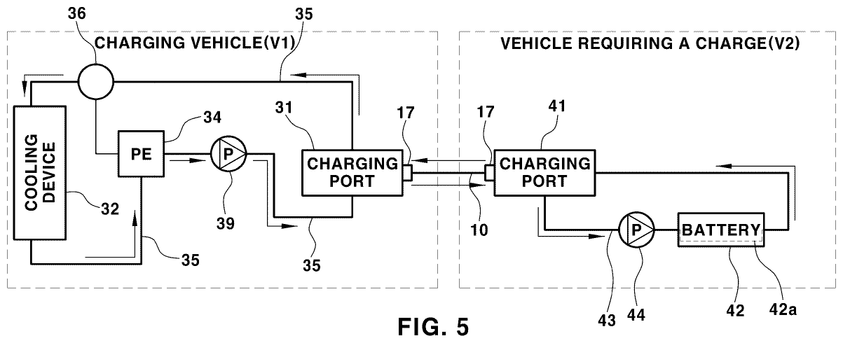

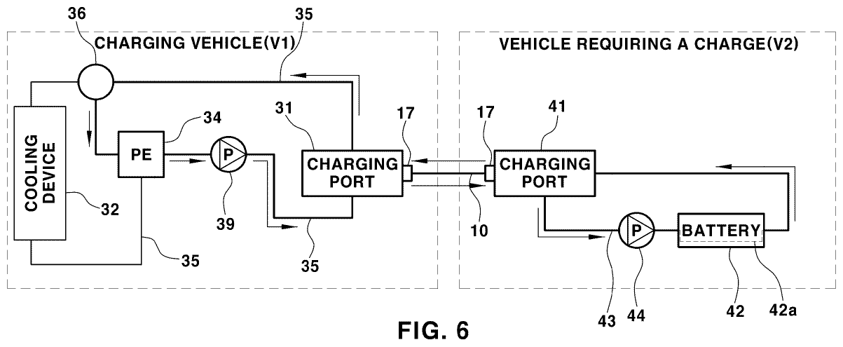

FIGS. 5 and 6 are views, each illustrating a state where the heat management performing apparatus according to the first embodiment of the present disclosure operates according to a heat management mode. FIG. 5 illustrates a state where the apparatus for performing V2V heat management according to the first embodiment of the present disclosure operates in a battery cooling mode. FIG. 6 illustrates a state where the apparatus for performing V2V heat management according to the first embodiment of the present disclosure operates in a battery temperature increasing mode.

As illustrated, the apparatus for performing V2V heat management may include a cooling device 32, and a heat supply device 34, which are mounted in the charging vehicle V1. In addition, the apparatus for performing V2V heat management includes a fluid circulation line 35 and a fluid regulation device. The fluid circulation line 35 is connected between the cooling device 32, the heat supply device 34, and the charging port 31 such that the cooling fluid circulates along the fluid circulation line 35. The fluid regulation device supplies the cooling fluid and regulates the flow of the cooling fluid in such a manner that the cooling fluid supplied from the cooling device 32 and the heat supply device 34 selectively circulates between the cooling device 32 and the charging port 31 and between the heat supply device 34 and the charging port 31.

According to the present disclosure, the fluid regulation device regulates the flow and circulation of the cooling fluid in such a manner that the cooling fluid cooled by the cooling device 32 or the cooling fluid heated by the heat supply device 34 is supplied to a vehicle requiring a charge V2 along the supply tube 15 of the charging cable 10.

According to the present disclosure, the cooling fluid may be a coolant. Furthermore, the cooling device 32 that cools and supplies the cooling fluid in the charging vehicle V1 may be a cooling module that includes a radiator, in which the heat carried in the cooling fluid is dissipated, and a cooling fan configured to blow air into the radiator.

In addition, in the charging vehicle V1, the cooling device 32 may be one that include a chiller. The chiller may be configured to cool the cooling fluid, which circulates along the fluid circulation line 35, using a cooling medium from a cooling system.

In this case, the cooling system may be an air conditioning system of the charging vehicle V1, and the chiller may be a heat exchanger in which heat exchange is performed between a refrigerant and the cooling fluid. Specifically, the chiller may be a plate-type heat exchanger that is provided such that a low-temperature, low-pressure refrigerant, which is supplied through a compressor, a condenser, and an expansion valve, and the cooling fluid, circulating along the fluid circulation line 35, flow through the plate-type heat exchanger.

Accordingly, the cooling fluid supplied from the cooling device 32 of the charging vehicle V1 may flow to the charging port 31 along the fluid circulation line 35 and then may be supplied to the vehicle requiring a charge V2 through the supply tube 15 of the charging cable 10.

In addition, the heat supply device 34 may be a device or a component that generates heat during battery charging in the charging vehicle V1. Specifically, the heat supply device 34 may be a vehicular power electronics (PE) system that, along with a battery (indicated by reference numeral 22 in FIG. 2), includes a charging-associated device and component that are used and generate heat during battery charging. In this case, examples of the charging-associated device and component may include an inverter and a converter.

Accordingly, when a battery 42 of the charging-required vehicle V2 is charged, the cooling fluid can be heated while flowing through a battery (indicated by reference number 22 in FIG. 2) heated in the charging vehicle V1 and through the heat supply device 34, such as an inverter or a converter. Subsequently, the cooling fluid can flow to the charging port 31 along the fluid circulation line 35 and then can be supplied to the vehicle requiring a charge V2 along the supply tube 15 of the charging cable 10.

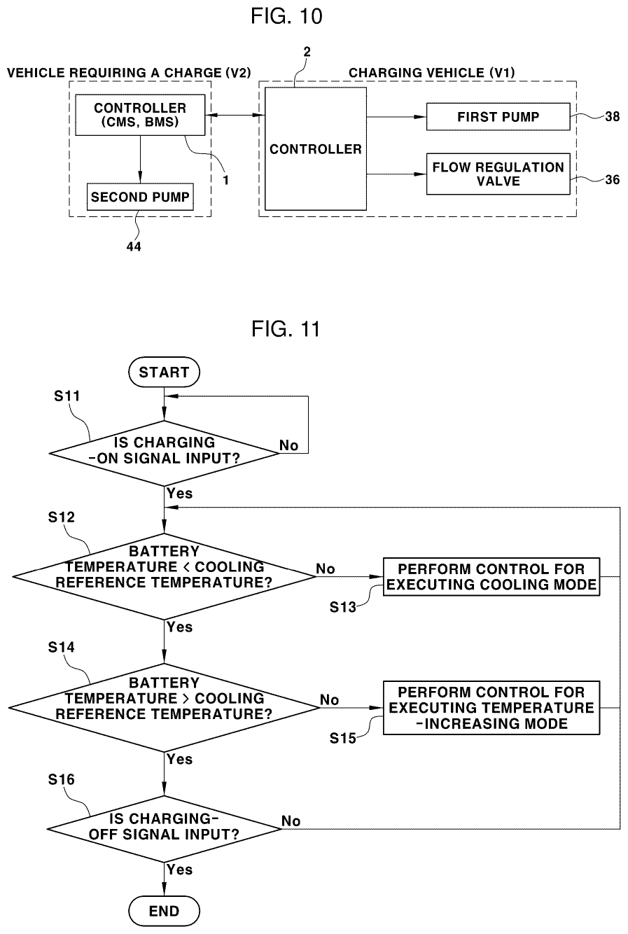

The fluid regulation device includes a flow regulation valve 36 and a first pump 38, which are installed on the fluid circulation line 35 in the charging vehicle V1, and a controller (indicated reference numeral 2 in FIG. 10) that controls the operation of the flow regulation valve 36 and the operation of the first pump 38 according to the heat management mode.

The fluid regulation device allows the cooling fluid flowing through the cooling device 32 or the heat supply device 34 to flow to the charging port 31 in the charging vehicle V1. Furthermore, the fluid regulation device allows the cooling fluid recovered from the vehicle requiring a charge V2 to flow from the charging port 31 to the cooling device 32 or the heat supply device 34.

To this end, the outlet-side fluid circulation line 35 of the heat supply device 34 is connected to a fluid outlet portion among tube connection components of the charging port 31. In this case, the fluid outlet portion of the charging port 31 is the portion that is connected to the supply tube 15 of the charging cable 10 when the charging connector 17 is fastened to the charging port 31.

In addition, the first pump 38 is installed on the outlet-side fluid circulation line 35 of the heat supply device 34, more specifically, on a portion of the fluid circulation line 35 that connects an outlet in the heat supply device 34 and the fluid outlet portion of the charging port 31. The operation of the first pump 38 is controlled by the controller (indicated by reference number 2 in FIG. 2).

In addition, the fluid circulation line 35 connected to a fluid inlet portion among the tube connection components of the charging port 31 branches, at a midway point, into two lines, one connected to the inlet side of the cooling device 32 and the other connected to the inlet side of the heat supply device 34. In this case, the fluid inlet portion of the charging port 31 is the portion that is connected to the recovery tube 16 of the charging cable 10 when the charging connector 17 is fastened to the charging port 31.

In addition, the flow regulation valve 36 is installed at a branching point where the fluid circulation line 35 connected to the fluid inlet portion of the charging port 31 branches into two lines. The flow regulation valve 36 may be an electronic valve of which the operation is controlled by the controller (indicated by reference numeral 2 in FIG. 10). In this case, the electronic valve is a three-way valve installed at the branching point.

The fluid circulation line 35 on the outlet side of the cooling device 32 is connected to the heat supply device 34 in the charging vehicle V1. The fluid circulation line 35 on the outlet side of the cooling device 32 joins the fluid circulation line 35 connected to the flow regulation valve 36 in the heat supply device 34.

Accordingly, when the first pump 38 drives, the cooling fluid flowing through either the cooling device 32 or the heat supply device 34 may be supplied from the charging vehicle V1 to the charging-required vehicle V2 over or via the fluid circulation line 35 through the charging port 31 and the charging cable 10, depending on the degree to which the flow regulation valve 36 is open.

In addition, the heat management performing apparatus according to the present disclosure further includes a heat exchange passage path 42a and a fluid circulation line 43. The heat exchange passage path 42a is provided in such a manner that the cooling fluid flows through the battery 42 in the charging-required vehicle V2. The fluid circulation line 43 is provided to connect between a fluid inlet portion of the charging port 41 and an inlet in the heat exchange passage path 42a and between an outlet in the heat exchange passage path 42a and a fluid outlet portion of the charging port 41 in such that the cooling fluid circulates between the charging port 41 and the battery 42 in the charging-required vehicle V2.

In addition, the heat management performing apparatus according to the present disclosure further includes a second pump 44 in the vehicle requiring a charge V2. The second pump 44 is installed on the fluid circulation line 43 between the fluid inlet portion of the charging port 41 and the inlet in the heat exchange passage path 42a provided in the battery 42. Accordingly, when the second pump 44 drives or operates, the cooling fluid supplied from the charging vehicle V1 through the charging cable 10 and the charging port 41 may be provided to the heat exchange passage path 42a in the battery 42.

In addition, the cooling fluid flowing through the heat exchange passage path 42a in the battery 42 may flow to the charging port 41 in the vehicle requiring a charge V2. Then, the cooling fluid may be supplied from the charging port to the charging vehicle V1 along the recovery tube 16 of the charging cable 10. Thereafter, the cooling fluid may be recovered or returned to the cooling device 32 or the heat supply device 34 in the charging vehicle V1.

In this manner, when the charging vehicle V1 and the vehicle requiring a charge V2 are connected to each other using the charging cable 10 having the fluid tube (indicated by both reference numerals 15 and 16), the cooling fluid may be supplied from the charging vehicle V1 to the vehicle requiring a charge V2 while the battery 42 is charged. In the vehicle requiring a charge V2, the temperature of the battery 42 being charged may be controlled by the cooling fluid supplied along the supply tube 15 of the charging cable 10.

Performing heat management of a battery to be charged and/or that is currently being charged can improve efficiency in battery charging and reduce electric energy necessary to increase the temperature of and/or cool the battery in the vehicle requiring a charge V2, thereby reducing battery charging time.

From FIG. 5, it can be seen that, in the battery cooling mode, the low-temperature cooling fluid circulating as to flow through the cooling device 32 is supplied from the charging vehicle V1 to the battery 42 of the vehicle requiring a charge V2. Accordingly, the battery 42 can be cooled by the cooling fluid.

From FIG. 6, it can be seen that, in the battery temperature-increasing mode, the high-temperature cooling fluid circulating as to flow through the power electronics (PE) system, which is the heat supply device 34, is supplied from the charging vehicle V1 to the battery 42 of the vehicle requiring a charge V2. Accordingly, the battery 42 can be temperature-increased by the cooling fluid.

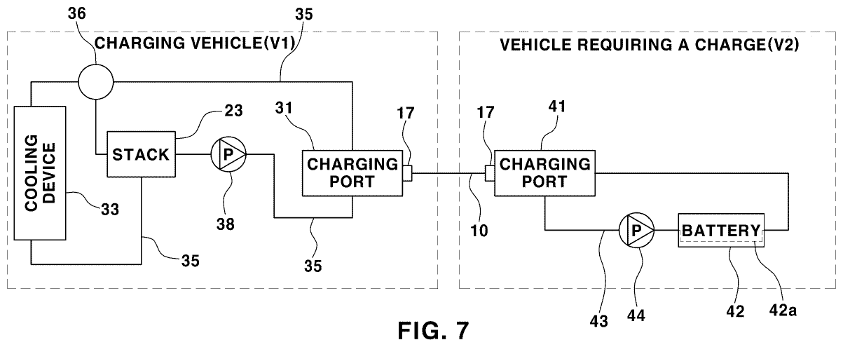

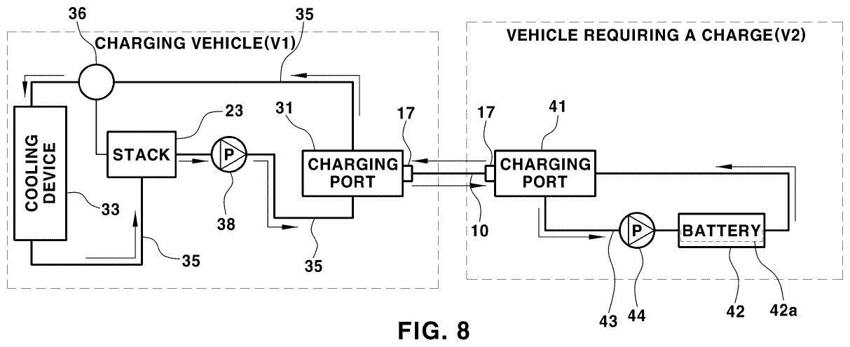

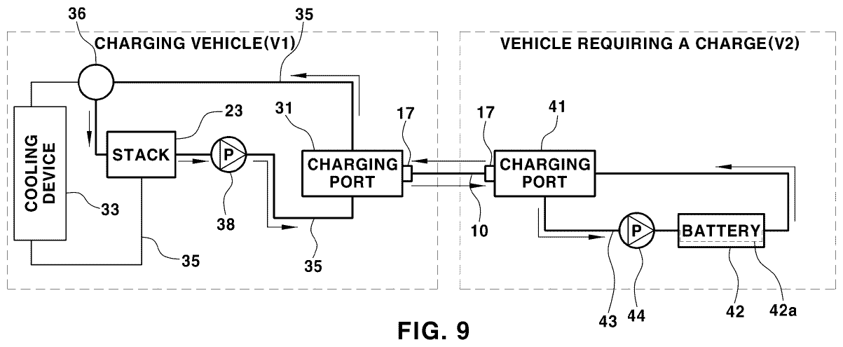

FIG. 7 is a view illustrating a configuration of an apparatus for performing V2V heat management according to a second embodiment of the present disclosure. FIG. 7 assumes that the charging vehicle V1 is a fuel cell electric vehicle. FIGS. 8 and 9 are views, each illustrating a state where the apparatus for performing V2V heat management according to the second embodiment of the present disclosure operates according to the heat management mode. FIG. 8 illustrates a state where the apparatus for performing V2V heat management according to the second embodiment of the present disclosure operates in the battery cooling mode. FIG. 9 illustrates a state where the apparatus for performing V2V heat management according to the second embodiment of the present disclosure operates in the battery temperature-increasing mode.

The apparatus capable of performing V2V heat management in FIG. 7 has the same configuration as the one in FIG. 4, with the exception that the heat supply device in FIG. 7 includes the fuel cell stack 23 and that a cooling device 33 is a stack cooling device configured to cool the fuel cell stack 23.

In addition to the fuel cell stack 23, the heat supply device here may further include a converter or an inverter, which is a charging-associated device or component. In addition, the cooling device 33 may be a stack cooling device for cooling a coolant in the fuel cell stack 23. In this case, the stack cooling device includes a radiator and a cooling fan.

In the fuel cell electric vehicle, the fuel cell stack 23 generates a large amount of heat and thus may advantageously be used to increase the temperature of the battery 42. In addition, a high-capacity cooling device 33 for cooling the fuel cell stack 23, which is installed in the fuel cell vehicle, may advantageously be used to cool the battery 42 of the vehicle requiring a charge V2.

From FIG. 8, it can be seen that, in the battery cooling mode, the low-temperature cooling fluid circulating as to flow through the cooling device 33 is supplied from the charging vehicle V1 to the battery 42 of the vehicle requiring a charge V2. Accordingly, the battery 42 can be cooled by the cooling fluid.

From FIG. 9, it can be seen that, in the battery temperature-increasing mode, the high-temperature cooling fluid circulating as to flow through the fuel cell stack 23, which is a heat supply device, is supplied from the charging vehicle V1 to the battery 42 of the vehicle requiring a charge V2. Accordingly, the battery 42 can be heated by the cooling fluid.

FIG. 10 is a block diagram illustrating control elements and operational elements of the apparatus for performing heat management according to the present disclosure. As illustrated, the apparatus for performing heat management according to the present disclosure further includes a controller 2 in the charging vehicle V1. The controller 2 receives battery state information of the vehicle requiring a charge V2 over a signal line (communication line) of the charging cable 10 from a controller 1 of the vehicle requiring a charge V2. In one example, the battery state information may include a temperature of the battery of the vehicle requiring a charge V2.

In this case, the controller 2 of the charging vehicle V1 is a controller that performs overall control associated with battery charging. The controller 2 is provided in such a manner as to communicate with the controller 1 of the charging-required vehicle V2 over the signal line of the charging cable 10.

In addition, the controller 1 of the vehicle requiring a charge V2 may be a controller that includes a charge management system (CMS) and a battery management system (BMS). Typically, a CMS and the BMS are provided in electric vehicles. The CMS is a controller that is responsible for overall control associated with charging. The BMS performs control that collects battery state information and manages a battery state.

Moreover, in typical electric vehicles, signal lines and communication terminals for communication with the CMS are provided in charging ports, including AC charging ports and DC charging ports, charging connectors, and charging cables for battery charging.

In addition, in typical electric vehicles, the CMS is communicatively connected to the BMS. Thus, the CMS may receive the battery state information collected by the BMS and then may transmit the received battery state information to the controller 2 of the charging vehicle V1 through the charging port 41 and the charging cable 10. Through this communication, the controller 2 of the charging vehicle V1 may acquire and check the battery state information of the vehicle requiring a charge V2.

FIG. 11 is a flowchart illustrating a V2V heat management method according to a third embodiment of the present disclosure. The V2V heat management method is described with reference to FIGS. 10 and 11.

In a state where the charging vehicle V1 and the vehicle requiring a charge V2 are connected to each other through the charging cable 10, the controller 2 of the charging vehicle V1 determines whether or not a charging-ON signal for starting charging is input (S11). When the charging-ON signal is input, the controller 2 of the charging vehicle V1 sends a request through the charging cable 10 to the controller 1 of the vehicle requiring a charge V2 for the battery state information.

Subsequently, the controller 2 of the charging vehicle V1 receives the battery state information from the controller 1 of the vehicle requiring a charge V2 and determines the heat management mode on the basis of the battery state information.

At this point, battery temperature of the vehicle requiring a charge V2 is compared with a preset cooling reference temperature (for example, 35° C.) (S12). When the battery temperature of the vehicle requiring a charge V2 rises to or above the preset cooling reference temperature, the controller 2 of the charging vehicle V1 determines that battery-cooling of the vehicle requiring a charge V2 is necessary, and determines the battery cooling mode as the heat management mode.

Subsequently, the controller 2 of the charging vehicle V1 and the controller 1 of the vehicle requiring a charge V2 collaborate to perform control for executing the battery cooling mode. In this mode, the low-temperature cooling fluid is supplied from the charging vehicle V1 to the vehicle requiring a charge V2 through the supply tube 15 of the charging cable 10 (S13).

At this point, the controller 2 of the charging vehicle V1 drives the first pump 38 and enables the controller 1 of the vehicle requiring a charge V2 to drive the second pump 44. Furthermore, the controller 2 controls the degree to which the flow regulation valve 36 is open, in such a manner that the fluid circulation line 35 on the inlet side of the cooling device 32 or 33 and the fluid circulation line 35 connected to the fluid outlet portion of the charging port 31 communicate with each other (refer to FIGS. 5 and 8).

Accordingly, the low-temperature cooling fluid supplied from the cooling device 32 or 33 is supplied to the vehicle requiring a charge V2 through the charging port 31 and the charging cable 10. Then, in the vehicle requiring a charge V2, the low-temperature cooling fluid flows through the heat exchange passage path 42a provided in the battery 42 while flowing along the fluid circulation line 43. Thereafter, the cooling fluid is recovered or returned back to the charging vehicle V1 through the charging port 41 and the charging cable 10. Consequently, the battery 42 of the vehicle requiring a charge V2 can be continuously cooled by the cooling fluid (refer to FIGS. 5 and 8).

In addition, the controller 2 of the charging vehicle V1 determines whether or not the battery temperature of the vehicle requiring a charge V2 falls below the preset cooling reference temperature, but exceeds a preset reference temperature (for example, 25° C.) for temperature increase (S14). When the preset reference temperature for temperature increase is exceeded, the controller 2 of the charging vehicle V1 determines that increasing the temperature of the battery of the vehicle requiring a charge V2 is also unnecessary. Thereafter, when a charging-OFF signal is input (S16), a heat management process is ended.

However, when the temperature of the battery 42 of the vehicle requiring a charge V2 falls below the preset cooling reference temperature and, at the same time, falls below the preset reference temperature for temperature increase, the controller 2 of the charging vehicle V1 determines that increasing the temperature of the battery of the vehicle requiring a charge V2 is necessary and determines the battery temperature-increasing mode as the heat management mode.

Subsequently, the controller 2 of the charging vehicle V1 and the controller 1 of the vehicle requiring a charge V2 collaborate to perform control for executing the battery temperature-increasing mode. In this mode, the high-temperature cooling fluid is supplied from the charging vehicle V1 to the vehicle requiring a charge V2 through the supply tube 15 of the charging cable 10 (S15).

At this point, the controller 2 of the charging vehicle V1 drives the first pump 38, and enables the controller 1 of the vehicle requiring a charge V2 to drive the second pump 44. Furthermore, the controller 2 controls the degree to which the flow regulation valve 36 is open, in such a manner that the fluid circulation line 35 on the inlet side of the heat supply device 23 or 34 and the fluid circulation line 35 connected to the fluid inlet portion of the charging port 31 communicate with each other (refer to FIGS. 6 and 9).

Accordingly, the high-temperature cooling fluid supplied from the heat supply device 23 or 34 is supplied to the vehicle requiring a charge V2 through the charging port 31 and the charging cable 10. Then, in the vehicle requiring a charge V2, the high-temperature cooling fluid flows through the heat exchange passage path 42a provided in the battery 42 while flowing along the fluid circulation line 43. Thereafter, the cooling fluid is recovered back to the charging vehicle V1 through the charging port 41 and the charging cable 10. Consequently, the temperature of the battery 42 of the vehicle requiring a charge V2 can continuously be increased by the cooling fluid (refer to FIGS. 6 and 9).

The embodiments of the present disclosure described in detail above are merely illustrative and do not impose any limitations on the scope of present disclosure as defined by the appended claims. Various modifications and improvements to the embodiments described herein made by a person of ordinary skill in the art including the fundamental concept of the present disclosure as defined in the following claims are also included within the claimed scope of the present disclosure.

What is claimed is:

1. An apparatus for performing vehicle-to-vehicle heat management, the apparatus comprising:
a charging cable including a fluid tube along which a cooling fluid flows, the charging cable configured to connect a vehicle requiring a charge equipped with a battery and a charging vehicle supplying electric power for charging the battery of the vehicle;
a cooling device provided in the charging vehicle and configured to cool the cooling fluid;
a heat supply device provided in the charging vehicle and configured to supply heat to the cooling fluid; and
a fluid regulation device configured to regulate a flow of the cooling fluid such that the cooling fluid having been cooled or heated by the cooling device or the heat supply device, respectively, is selectively supplied to the vehicle along the fluid tube of the charging cable, in order to cool or increase a temperature of the battery of the vehicle using the cooling fluid.

2. The apparatus of claim 1, further comprising:
a heat exchange passage provided in the battery of the vehicle such that the cooling fluid supplied along the fluid tube of the charging cable flows through the heat exchange passage and the battery is cooled or the temperature of the battery is increased while the cooling fluid flows through the heat exchange passage.

3. The apparatus of claim 1, wherein the fluid tube comprises:
a supply tube along which the cooling fluid is supplied from the charging vehicle to the vehicle; and
a recovery tube along which the cooling fluid that cools or increases the temperature of the battery is returned from the vehicle to the charging vehicle.

4. The apparatus of claim 1, wherein the cooling device comprises:
a radiator configured to dissipate heat carried by the cooling fluid; and
a cooling fan configured to blow air into the radiator.

5. The apparatus of claim 1, wherein the cooling device comprises:
a chiller configured to cool the cooling fluid by heat exchange with a refrigerant.

6. The apparatus of claim 1, wherein the heat supply device comprises:
a battery of the charging vehicle; and
a power electronics component generating heat when charged using the battery of the charging vehicle,
wherein the cooling fluid is a coolant that cools the battery of the charging vehicle and the power electronics component.

7. The apparatus of claim 1, wherein the charging vehicle supplies electric power generated in a fuel cell stack, which is a primary electric power source for the charging vehicle, or electric power stored in a battery of the charging vehicle, which is an auxiliary electric power source for the charging vehicle, to the vehicle.

8. The apparatus of claim 7, wherein the cooling fluid is a coolant configured to cool the fuel cell stack, and
wherein the cooling device comprises:
a radiator configured to dissipate heat carried by the cooling fluid; and
a cooling fan configured to blow air into the radiator.

9. The apparatus of claim 7, wherein the heat supply device is the fuel cell stack that generates electric power while the battery of the vehicle is charged, and
wherein the cooling fluid is a coolant configured to cool the fuel cell stack.

10. The apparatus of claim 1, wherein the fluid regulation device comprises:
a controller configured to determine a heat management mode based on battery state information of the vehicle received from the vehicle via the charging cable, and output a control signal according to the determined heat management mode; and
a pump and a fluid regulation valve, wherein operation of the pump and the fluid regulation valve is controlled by a control signal output by the controller, such that a cooling fluid, cooled by the cooling device or heated by the heat supply device, is supplied to a charging port of the charging vehicle, the fluid tube of the charging cable being connected to the charging port.

11. An apparatus for performing vehicle-to-vehicle heat management, the apparatus comprising:
a charging cable including a fluid tube along which a cooling fluid for cooling or increasing a temperature of a battery of a vehicle requiring a charge flows, the charging cable configured to connect the vehicle equipped with the battery and a charging vehicle supplying electric power for charging the battery of the vehicle; and
a heat exchange passage provided in the battery of the vehicle such that, the cooling fluid supplied along the fluid tube of the charging cable flows through the heat exchange passage and the battery is cooled or the temperature of the battery is increased while the cooling fluid flows through the heat exchange passage.

12. A vehicle-to-vehicle heat management method comprising:
determining, by a controller, whether or not a charging-ON signal is input when a vehicle requiring a charge equipped with a battery and a charging vehicle supplying electric power for charging the battery of the vehicle are connected to each other by a charging cable having a fluid tube along which a cooling fluid flows;
receiving, by the controller, battery state information of the vehicle via the charging cable when it is determined that the charging-ON signal is input;
determining, by the controller, a heat management mode based on the battery state information; and
controlling, by the controller, an operation of a fluid regulation device such that the cooling fluid, cooled by a cooling device or heated by a heat supply device in the charging vehicle is supplied to the vehicle along the fluid tube of the charging cable, according to the determined heat management mode in order to cool or increase a temperature of the battery of the vehicle using the cooling fluid.

13. The vehicle-to-vehicle heat management method of claim 12, wherein a heat exchange passage, through which the cooling fluid supplied from the charging vehicle along the fluid tube of the charging cable flows, is provided in the battery of the vehicle.

14. The vehicle-to-vehicle heat management method of claim 12, further comprising:
supplying the cooling fluid from the charging vehicle to the vehicle through a supply tube of the fluid tube; and
returning the cooling fluid that cools or increases the temperature of the battery from the vehicle to the charging vehicle through a recovery tube of the fluid tube.

15. The vehicle-to-vehicle heat management method of claim 12, further comprising:
dissipating, by a radiator of the cooling device, heat carried by the cooling fluid; and
supplying, by a cooling fan, air into the radiator.

16. The vehicle-to-vehicle heat management method of claim 12, further comprising:
cooling, by a chiller of the cooling device, the cooling fluid through heat exchange with a refrigerant.

17. The vehicle-to-vehicle heat management method of claim 12, wherein the heat supply device comprises:
a battery of the charging vehicle; and
a power electronics component generating heat when charged using the battery of the charging vehicle,
wherein the cooling fluid is a coolant that cools the battery of the charging vehicle and the power electronics component.

18. The vehicle-to-vehicle heat management method of claim 12, further comprising: supplying electric power generated in a fuel cell stack, which is a primary electric power source for the charging vehicle, or electric power stored in a battery of the charging vehicle, which is an auxiliary electric power source for the charging vehicle, as the electric power for charging the battery of the vehicle.

19. The vehicle-to-vehicle heat management method of claim 18, further comprising:
dissipating, by a radiator, heat carried by the cooling fluid; and
blowing, by a cooling fan, air into the radiator,
wherein the cooling fluid is a coolant that cools the fuel cell stack.

20. The vehicle-to-vehicle heat management method of claim 18, wherein the heat supply device is the fuel cell stack that generates electric power while the battery of the vehicle is charged, and
wherein the cooling fluid is a coolant that cools the fuel cell stack.
